(19) United States
(12) Patent Application Publication
(10) Pub. No.: US 2015/0289040 A1
(43) Pub. Date: Oct. 8, 2015

(54) ACCOMMODATING BAG CAPABLE OF PLAYING AUDIO SIGNAL WIRELESSLY

(71) Applicant: FU-YI HSU, TAITUNG COUNTY 962 (TW)

(72) Inventor: FU-YI HSU, TAITUNG COUNTY 962 (TW)

(21) Appl. No.: 14/616,974

(22) Filed: Feb. 9, 2015

(30) Foreign Application Priority Data
Apr. 2, 2014 (TW) 103205711
Apr. 9, 2014 (TW) 103206150

(51) Int. Cl. H04R 1/02; B65D 25/02

(52) U.S. Cl. CPC H04R 1/02; B65D 25/02

(57) ABSTRACT

The present invention provides an accommodating bag capable of playing audio signal wirelessly, which comprises a top cover, a bottom cover, and a speaker. The top and bottom covers are connected on an adjacent side. They close to form an accommodating space that accommodates an electronic device. The speaker is connected electrically to a wireless transmission unit and disposed in any of the covers. The electronic device transmits an audio signal wirelessly to the speaker for playing via the wireless transmission unit. Accordingly, the drawbacks of blocking sound from built-in speakers inability in sharing sound with multiple people with clarity, larger size of external speakers, and inconvenience in carrying occurred in the protective housings, cases, or accommodating bags according the prior art can be improved.

### FIELD OF THE INVENTION

The present invention relates generally to an accommodating bag capable of playing audio signal wirelessly, and particularly to an accommodating bag capable of accommodating and protecting electronic devices and playing audio signal wirelessly.

### BACKGROUND OF THE INVENTION

Technologies advance day by day. Novel electronic products are introduced continuously, from the past desktop computers and notebook computers to the must-have modern smartphones and convenient tablet computers. Smartphones and tablet computers bring unprecedented convenience for humans. Currently, people no longer need to rely on heavy notebook computer for receiving and sending emails, preparing electronic presentations or even processing e-commerce, searching the Internet, and playing games. Instead, only a lightweight, thin, and easy-to-carry tablet computer or even a smartphone can achieve the above functions.

The display of a smartphone or a tablet computer is, without exception, a touch panel. In order to reduce the size, a general method is to assemble the electronic processing device and the display within a tablet. Nonetheless, unlike a notebook computer having a top and a bottom cover, the touch panel is not protected. Thereby, irresistible wear, scratches, oil, or dusts might happen frequently to the cover or screen of a tablet computer. Accordingly, various accessories such as protective housings, cases, or accommodating bags for smartphones or tablet computers are designed by different vendors for protecting them.

Current smartphones or tablet computers own the functions of connecting to the Internet, calendar, organizer, electronic books, camera, or even playing video. Although a built-in speaker is normally included in smartphones or tablet computers, the range for playing audio signal is quite limited when shared with more people in an open space; not all people can hear clearly the content of the audio signal. Although an external speaker can improve the range of sound and enable everyone to hear the sound with clarity, the volume of an external speaker is larger, making it difficult to carry for playing anytime and anywhere. In addition, general protective housings, cases, or accommodating bags of smartphones or tablet computers have to be aligned accurately to the opening of speakers to avoid covering the sound by the protective means. Once the sound is covered, the volume of the sound will become even smaller and unclear in playing. Although raising the volume of the sound can increase the range and clarity of the sound, the quality of sound is affected and the power consumption is even increased. Accordingly, a product that can protect smartphones or tablet computers as well as playing sound has become highly demanded.

### SUMMARY

An objective of the present invention is to provide an accommodating bag capable of playing audio signal wirelessly. The present invention can improve the drawbacks of blocking sound from built-in speakers, inability in sharing sound with multiple people with clarity, larger size of external speakers, and inconvenience in carrying occurred in the protective housings cases, or accommodating bags according the prior art.

In order to achieve the objective and efficacy as described above, the accommodating bag capable of playing audio signal wirelessly comprises a top cover, a bottom cover, and a speaker. The top and bottom covers are connected on an adjacent side. They close to form an accommodating space that accommodates an electronic device. The speaker is connected electrically to a wireless transmission unit and disposed in any of the covers. The electronic device transmits an audio signal wirelessly to the speaker for playing via the wireless transmission unit.

### BRIEF DESCRIPTION OF THE DRAWINGS

FIG. 1 shows a structural schematic diagram according to a first embodiment of the present invention;

FIG. 2 shows a structural diagram inside the connecting part according to a first embodiment of the present invention;

FIG. 3 shows a structural schematic diagram according to a second embodiment of the present invention; and

FIG. 4 shows a block diagram of electrical connection according to the present invention.

### DETAILED DESCRIPTION

In order to make the structure and characteristics as well as the effectiveness of the present invention to be further understood and recognized, the detailed description of the present invention is provided as follows along with embodiments and accompanying figures.

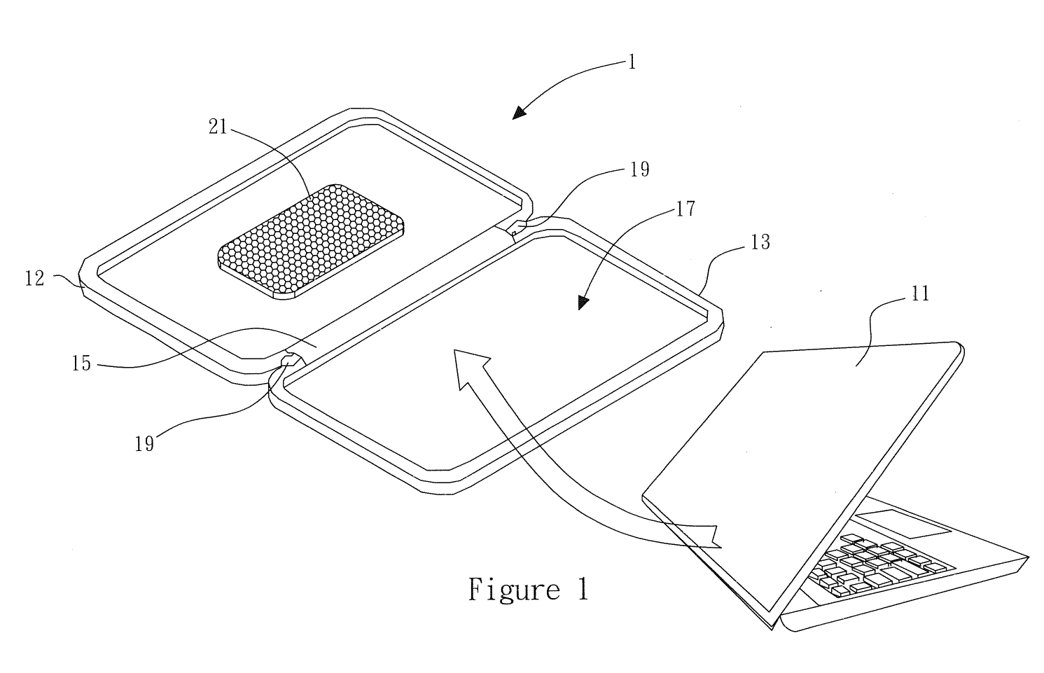

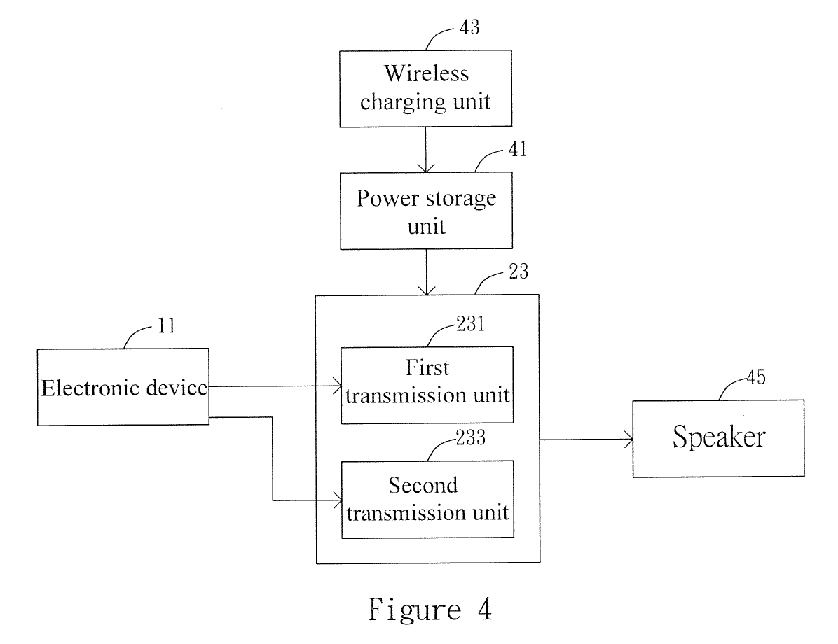

The present invention relates to an accommodating bag capable of playing audio signal. First, please refer to FIG. 1 and FIG. 4, which show structural schematic diagrams according the first embodiment of the present invention. The accommodating ba according to the present invention mainly comprises a bag 1, a speaker, and a wireless transmission unit 23.

The bag 1 atop cover 12 and a bottom cover 13 connected reciprocally on one side and forming a connecting part 15. By closing the top and bottom covers 12, 13, an accommodating space is formed therein. The accommodating space 17 accommodates an electronic device 11. In addition, a fixing member 19 is disposed at the bottom cover 13 or on the outer side of the bottom cover 13 for connecting the two covers. The speaker 45 and the wireless transmission unit 23 are disposed in the bag 1, respectively. The speaker 45 is connected electrically with the wireless transmission unit 23.

The top cover 12 and the bottom cover of the bag 1 are connected via the fixing member 19. Thereby, the two covers can open or close correspondingly. The fixing member 19 can be a Velcro, a zipper, or an edge magnetic buckle. The speaker 45 transmits the audio data to the wireless transmission unit 23 via the electronic device 11. Then the wireless unit 23 transmits the signal to the speaker 45. Besides, the wireless transmission unit 23 is a Bluetooth device.

A user can connect the electronic device 11, such as a notebook computer, to the wireless transmission unit 23. When the user plays the audio signal, the audio data is transmitted to the wireless transmission unit 23 connected electrically with the electronic device 11. Then the wireless transmission unit 23 transmits the audio signal to the speaker 45 wirelessly.

The top cover 12 or the bottom cover 13 contains a space for disposing the speaker 45 and another space for disposing the wireless transmission unit 23. The bag 1 includes a plurality of holes 21 at the positions corresponding to the speaker 45. Thereby, the sound can be propagated smoothly and without obstruction to the user or the nearby people for listening.

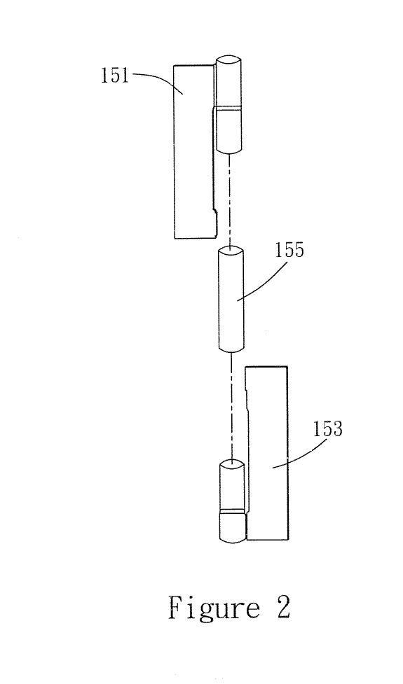

Please refer to FIG. 2, which shows a structural diagram inside the connecting part according to a first embodiment of the present invention. The connecting part 15 according to the present invention comprises a first hinge 151, a second hinge 153, and a connecting member 155. The first hinge 151 is disposed on one side of the top cover 12. The second hinge 153 is disposed on one side of the bottom cover 13. In addition, the first hinge 151 is connected with the second hinge 153; the connecting member 155 penetrates and connects the first and second hinges 151, 153.

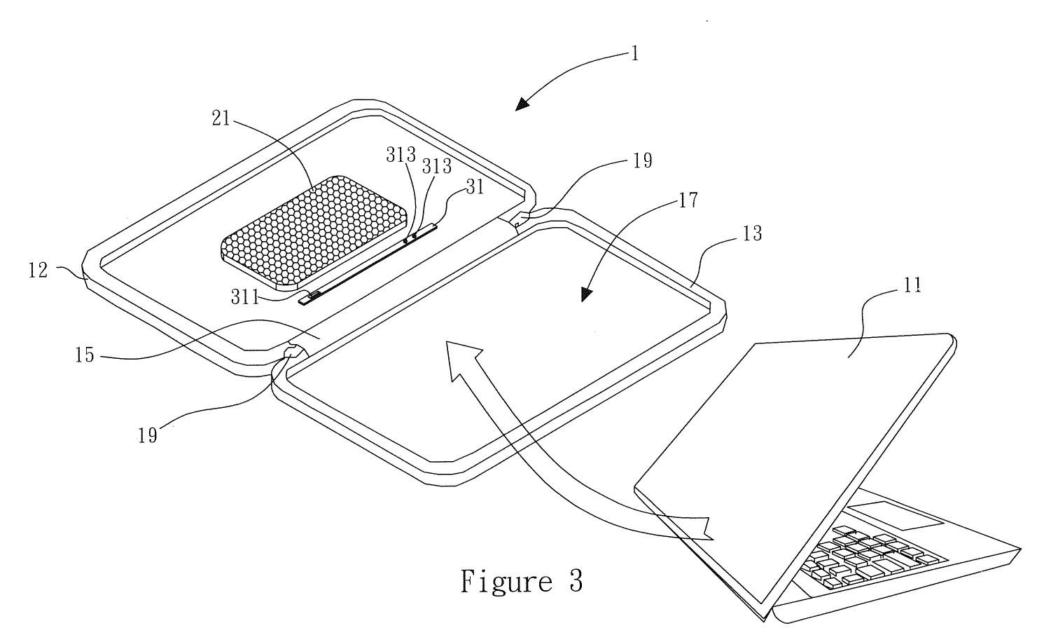

Please refer to FIG. 3, which shows a structural schematic diagram according to a second embodiment of the present invention. The difference between the second embodiment and the first one is that the top cover 12 includes a plurality of transmission jacks 31, which include a USB jack 311 and an audio jack 313. The user can choose to connect the electronic device 11 and the speaker wiredly according to personal requirement. In FIG. 3, the bag 1, the speaker 45, the fixing member 19, and the connecting member 155 are identical to those in the first embodiment. Hence, the details will not be described again.

Please refer to FIG. 4, which shows a block diagram of electrical connection according to the present invention. The electrical connection between the electrical device 11 and the speaker 45 includes connecting electrically the electronic device 11 to the wireless transmission unit 23. The wireless transmission unit 23 comprises a first transmission unit 231 and a second transmission unit 233. The first and second transmission units 231, 233 are connected electrically to the speaker 45. Besides, a power storage unit 41 is further disposed and connected electrically to the wireless transmission unit 23. Moreover, a wireless charging unit 43 is disposed and connected electrically to the power storage unit 41.

The power storage unit 41 and the wireless charging unit 43 are both disposed inside the top cover 12 or the bottom cover 13. The power storage unit 41 is used as the power of the wireless transmission unit. The wireless charging unit 43 is used for charging the power storage unit 41.

When the user adopts the second embodiment of the present invention for playing the audio signal, the electronic device 11, such as a notebook computer, can either transmit the audio data to the first transmission unit 231 and then to the speaker 45 wirelessly, or use the USB jack 311 or audio jack disposed at the second transmission unit 233 to transmit the audio data to the speaker 45.

To sum up the accommodating bag capable of playing audio signal wirelessly according to the present invention has the following advantages:
1. The accommodating bag according to the present invention can protection a user's electronic device 11 by using the bag 1 comprising the top and bottom covers 12, 13. Thereby, wear, scratches, oil, or dusts on the housing of the electronic device 11 can be avoided.
2. The accommodating bag according to the present invention integrates the speaker 45. Thereby, multiple people can share the effect of playing the audio signal from the electronic device 11.
3. The accommodating bag according to the present invention can transmit the audio signal of the electronic device 11 to the speaker 45 using the wireless transmission unit 23. Thereby, the situation in which the electronic device 11 or the speaker 45 falls or is bumped because the user drags the transmission wire if the electronic device 11 and speaker 45 are connected wiredly can be prevented.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. An accommodating bag capable of playing audio signal wirelessly, comprising:
a bag, comprising atop cover and a bottom cover, one side of said top cover connected with one side of said bottom cover and forming a connecting part, and said top cover and said bottom cover closing to form an accommodating space therein; and
a speaker, disposed in said bag along with a wireless transmission unit, and connected electrically with said wireless transmission unit.

2. The accommodating bag capable of playing audio signal wirelessly of claim 1, wherein a power storage unit is disposed inside said bag.

3. The accommodating bag capable of playing audio signal wirelessly of claim 2, wherein said wireless transmission unit is connected electrically with said power storage unit.

4. The accommodating bag capable of playing audio signal wirelessly of claim 2, wherein said power storage unit is connected electrically to a wireless charging unit disposed inside said bag.

5. The accommodating bag capable of playing audio signal wirelessly of claim wherein said wireless transmission unit comprises a plurality of transmission jacks.

6. The accommodating bag capable of playing audio signal wirelessly of claim 1, wherein said bag comprises a plurality of holes at the positions corresponding to said speaker.

7. The accommodating bag capable of playing audio signal wirelessly of claim 1, wherein said connecting part further comprises:
a first hinge, disposed on one side of said top cover; and
a second hinge, disposed on one side of said bottom cover, connected to said first hinge, and including a connecting member for penetrating and connecting said first hinge and said second hinge.

8. The accommodating bag capable of playing audio signal wirelessly of claim 1, wherein a fixing member is disposed at said bottom cover or on a surface of said bottom cover.

9. The accommodating bag capable of playing audio signal wirelessly of claim 8, wherein said fixing member is a Velcro, a zipper, or an edge magnetic buckle.
